(19) United States
(12) Patent Application Publication
(10) Pub. No.: US 2014/0237491 A1
(43) Pub. Date: Aug. 21, 2014

(54) OPTICAL DISC DRIVE AND MAIN FRAME OF OPTICAL DISC DRIVE

(71) Applicant: TOSHIBA SAMSUNG STORAGE TECHNOLOGY KOREA CORPORATION, Suwon-si (KR)

(72) Inventors: Hyoung Woo JO, Suwon-si (KR); Seong Yeon PARK, Suwon-si (KR); Young Sun JUNG, Suwon-si (KR); Jeong Hun CHOE, Suwon-si (KR)

(73) Assignee: TOSHIBA SAMSUNG STORAGE TECHNOLOGY KOREA CORPORATION, Suwon-si (KR)

(21) Appl. No.: 14/183,598

(22) Filed: Feb. 19, 2014

(30) Foreign Application Priority Data
Feb. 20, 2013 (KR) 10-2013-0018132

(51) Int. Cl. G11B 17/03

(52) U.S. Cl. CPC G11B 17/03
USPC 720/601

(57) ABSTRACT

Provided is an optical disc drive that may prevent an optical disc from dropping during an unclamping operation. The optical disc drive includes a main frame to support the optical disc drive and a disc tray in which the optical disc is disposed, and one or more stopper mechanisms to prevent the optical disc disposed on the disc tray from dropping.

### CROSS-REFERENCE TO RELATED APPLICATION(S)

This application claims the benefit under 35 USC § 119(a) of Korean Patent Application No. 10-2013-0018132, filed on Feb. 20, 2013, in the Korean Intellectual Property Office, the entire disclosure of which is incorporated herein by reference for all purposes.

### BACKGROUND

b 1. Field

The following description relates to an optical disc drive that includes a mechanism to prevent an optical disc from separating from a disc tray.

2. Description of Related Art

An optical disc drive may record data on an optical disc and read data recorded on the optical disc. An optical pickup disposed on the optical disc drive may include various components, for example, a laser diode, a photo diode, a diffraction grid, a sensor lens, a mirror, an objective lens, and the like. The various components may perform a function of recording data and reading data that was previously recorded.

An optical disc may be loaded to and unloaded from the optical disc drive using a disc tray that slides into and out of the optical disc drive. While inserted into the drive, the optical disc may be spun using a spindle motor. To record or read data on the loaded optical disc, a connection between the spindle motor and a clamper is typically needed in advance. Clamping refers to an operation in which the spindle motor is connected to the clamper, and unclamping refers to an operation in which the connected spindle motor is separated from the clamper.

The disc tray may include an inwardly protruding hook which fixes the optical disc to the disc tray while the optical disc is unloaded from the optical disc drive. However, when the optical disc drive is tilted at a predetermined angle, or in a state in which the optical disc is disposed in a vertical direction, a drop of the optical disc may occur during the unclamping operation. When the optical disc drops, the optical disc drive may perform an incorrect operation on the optical disc and/or the optical disc may be damaged during an unloading operation.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In an aspect, there is provided an optical disc drive, including a disc tray configured to support an optical disc, a main frame which supports the optical disc drive and the disc tray, and a stopper mechanism disposed on the main frame and which is configured to prevent the optical disc from dropping while the optical disc is positioned in the disc tray.

The optical disc drive may be a vertical optical disc drive, and the stopper mechanism may hold the optical disc in order to prevent a free fall of the optical disc due to a force of gravity while an unclamping operation of the optical disc drive is performed.

The stopper mechanism may comprise a shape of a rib to hold the optical disc toward a direction in which the optical disc drive is tilted.

The optical disc drive may further comprise a hook disposed on the disc tray, wherein the stopper mechanism holds the optical disc in order to prevent separation of the optical disc from the hook of the disc tray.

The stopper mechanism may prevent the drop of the optical disc from occurring when the optical disc drive is tilted at a predetermined angle while the optical disc drive is disposed in a vertical direction.

The stopper mechanism may comprise a center that is within a predetermined distance from a reference axis to which a center of the optical disc is connected, and may hold an end portion of the optical disc in a vertical direction relative to a plane of the optical disc.

The stopper mechanism may hold the end portion of the optical disc, which is offset by a predetermined distance, in a vertical direction relative to a plane of the optical disc.

The stopper mechanism may comprise a first stopper mechanism comprising a center that is within a predetermined distance from a reference axis to which a center of the optical disc is connected, and which holds an end portion of the optical disc in a vertical direction relative to a plane of the optical disc, and a second stopper mechanism that holds the end portion of the optical disc, and which is offset by a predetermined distance, in the vertical direction relative to the plane of the optical disc.

The disc tray may comprise at least one hook that is configured to hold the optical disc in a vertical direction relative to a plane of the optical disc.

The optical disc may be held by the at least one hook while the optical disc drive is disposed in the vertical direction, and held by the stopper mechanism when the optical disc drive is tilted at a predetermined angle while the optical disc drive is disposed in the vertical direction.

In an aspect, there is provided a main frame of an optical disc drive, the main frame including a stopper mechanism configured to prevent an optical disc disposed on a disc tray from dropping, wherein the stopper mechanism is configured to prevent dropping of the optical disc when the optical disc drive is tilted at a predetermined angle while the optical disc drive is disposed in a vertical direction.

During an unclamping operation of the optical disc drive, the stopper mechanism may hold the optical disc to prevent a free fall of the optical disc due to a force of gravity.

The stopper mechanism may comprise a shape of a rib to hold the optical disc toward a direction in which the optical disc drive is tilted.

The stopper mechanism may hold the optical disc in order to prevent separation of the optical disc from a hook disposed on the disc tray.

The stopper mechanism may comprise a first stopper mechanism that has a center within a predetermined distance from a reference axis to which a center of the optical disc is connected and which holds an end portion of the optical disc in a vertical direction relative to a plane of the optical disc, and a second stopper mechanism configured to hold the end portion of the optical disc and which is offset by a predetermined distance in the vertical direction relative to the plane of the optical disc.

In an aspect, there is provided an optical disc drive, including a disc tray comprising a hook that is configured to hold an optical disc while the optical disc drive is disposed in a vertical direction, and a main frame comprising a stopper mechanism configured to hold the optical disc when the optical disc drive is tilted at a predetermined angle while the optical disc drive is disposed in the vertical direction.

The stopper mechanism may prevent the optical disc from a free fall by a force of gravity while an unclamping operation of the optical disc drive is performed.

The stopper mechanism may be configured to hold the optical disc in order to prevent separation of the optical disc from the hook of the disc tray.

The stopper mechanism may comprise a first stopper mechanism that has a center within a predetermined distance from a reference axis to which a center of the optical disc is connected and which holds an end portion of the optical disc in a vertical direction relative to a plane of the optical disc, and a second stopper mechanism that holds the end portion of the optical disc and which is offset by a predetermined distance, in the vertical direction relative to the plane of the optical disc.

Other features and aspects will be apparent from the following detailed description, the drawings, and the claims.

### BRIEF DESCRIPTION OF THE DRAWINGS

FIG. 1 is a diagram illustrating an example of an optical disc drive positioned in a horizontal direction.

FIG. 2 is a diagram illustrating an example of an optical disc drive positioned in a vertical direction.

FIGS. 3A and 3B are diagrams illustrating enlarged examples of a stopper mechanism according to various aspects.

FIG. 4 is a diagram illustrating an example of a stopper mechanism of an optical disc drive that is positioned in a vertical direction.

### Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following detailed description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. The progression of processing steps and/or operations described is an example; however, the sequence of and/or operations is not limited to that set forth herein and may be changed as is known in the art, with the exception of steps and/or operations necessarily occurring in a certain order. Also, description of well-known functions and constructions may be omitted for increased clarity and conciseness.

The features described herein may be embodied in different forms, and are not to be construed as being limited to the examples described herein. Rather, the examples described herein have been provided so that this disclosure will be thorough and complete, and will convey the full scope of the disclosure to one of ordinary skill in the art.

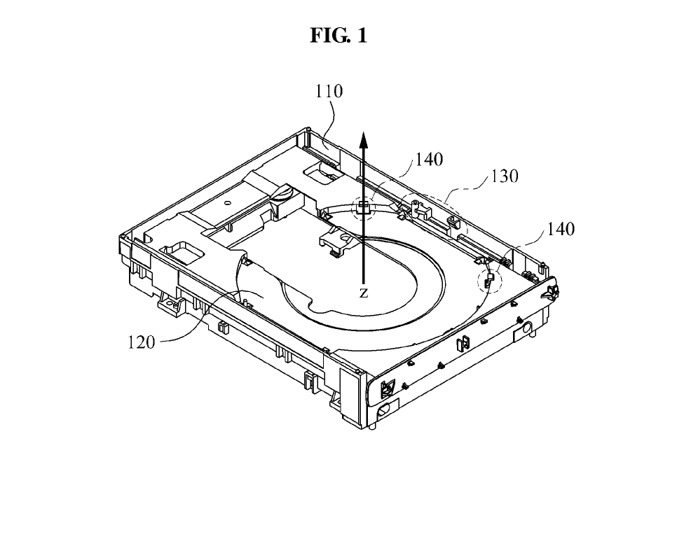

FIG. 1 illustrates an example of an optical disc drive that is positioned in a horizontal direction.

Referring to FIG. 1, the optical disc drive includes a main frame 110 that supports the optical disc drive and a disc tray 120 in which an optical disc may be positioned. The optical disc drive, for example, may be provided in a form of a half height type. The disc tray 120 may receive an optical disc and insert the optical disc into the optical disc drive, and may be loaded to and unloaded from the optical disc drive.

When the disc tray 120 is unloaded from the optical disc drive, the disc tray 120 may be externally ejected from the optical disc drive to enable the optical disc to be placed on the disc tray 120 and to be inserted into the optical disc drive. As another example, if an optical disc is already loaded on the disc tray 120, the disc tray 120 may be externally ejected and the previously loaded disc may be removed. When the disc tray 120 is loaded and the disc tray 120 is drawn into the optical disc drive again, a reading process of the optical disc may be performed.

The disc tray 120 may include at least one hook 140 to hold the optical disc in a vertical direction relative to a plane of the optical disc. For example, the hook 140 may be provided in a shape protruding toward the center of the disc tray 120. Hereinafter, the vertical direction relative to the plane of the optical disc is assumed to be a Z-axial direction for ease of description. Further, the plane of the optical disc indicates a plane on which data is recorded.

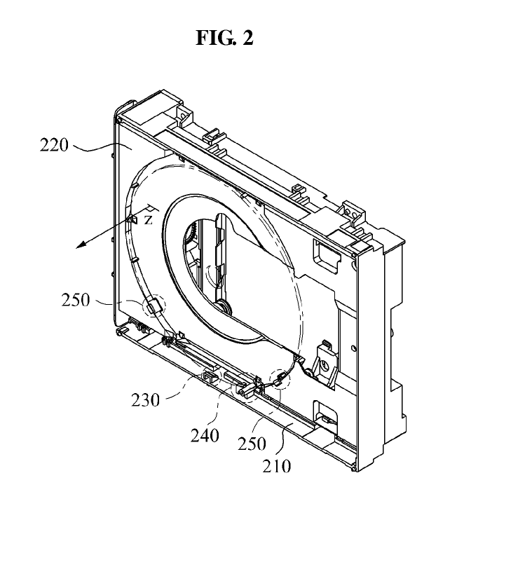

In FIG. 1, the optical disc drive is positioned in the horizontal direction such that gravity assists the disc from being dislodged from the disc tray 120. However, when the optical disc drive is positioned to operate in a vertical direction, for example, as illustrated in FIG. 2, an optical disc included in the optical disc drive may drop or become dislodged easily due to a relatively minor tilt. For example, when the optical disc drive is positioned to operate in a vertical direction, an optical disc may experience a free fall resulting from a tilted state which may lead to the optical disc being dropped during an unclamping operation in which a clamper is separated from a spindle motor.

According to various aspects, an optical disc drive may include a stopper mechanism 130 in the main frame 130 to prevent the drop of the optical disc. The stopper mechanism 130 may hold the optical disc in order to prevent a free fall due to a weight of the optical disc when the unclamping operation of the optical disc drive is performed.

In addition, the optical disc drive may prevent separation of the optical disc from the disc tray 120 through use of the stopper mechanism 130 of the main frame 110 when the disc tray 120 is externally ejected from the optical disc drive. As an example, when the optical disc drive is in a vertical direction, the stopper mechanism 130 of the main frame 110 may hold the optical disc such that the optical disc is hooked to the hook 140 and not separated from the disc tray 120 although the optical disc drive is tilted. Accordingly, although the optical disc drive performs the unloading operation in a tilted state, the optical disc may be fixed to the disc tray 120 and externally ejected.

According to various aspects, the optical disc drive may include the stopper mechanism 130 of the main frame 110 in addition to the hook 140 of the disc tray 120, and thus, may prevent separation of the optical disc from the disc tray 120 although the optical disc drive is positioned to operate in a vertical direction. Accordingly, an operational stability of the optical disc drive may be increased and damage to an optical disc due to an incorrect operation of the optical disc drive may be prevented.

FIG. 2 illustrates an example of an optical disc drive positioned in a vertical direction.

Referring to FIG. 2, the optical disc drive has a main frame that includes a disc tray 220 in which an optical disc is positioned, a first stopper mechanism 230, and a second stopper mechanism 240. The first stopper mechanism 230 and the second stopper mechanism 240 perform a function to prevent the optical disc from dropping. For example, a drop of the optical disc may occur when the optical disc drive is tilted at a predetermined angle, in a state in which the optical disc drive is vertically disposed.

As an example, the first stopper mechanism 230 and the second stopper mechanism 240 may be provided in a shape of a rib to hold the optical disc in a direction in which the optical disc drive is tilted. When the disc tray 220 is unloaded, the first stopper mechanism 230 and the second stopper mechanism 240 may hold the optical disc to prevent separation of the optical disc from a hook 250 of the disc tray 220.

The first stopper mechanism 230 and the second stopper mechanism 240 may have a center within a predetermined distance from a reference axis to which a center of the optical disc is connected. Accordingly, the first and second stopper mechanisms 230 and 240 may hold an end portion of the optical disc which is offset by a predetermined distance in a vertical direction relative to a plane of the optical disc. As a non-limiting example, the second stopper mechanism 240 may hold the end portion of the optical disc such that it is offset by approximately 2.0 millimeters (mm) to 4 0 mm from a floor plane of the main frame 210 toward a center of the optical disc in the vertical direction, relative to the plane of the optical disc. Here, the floor plane of the main frame 210 refers to a plane that is disposed in a lower portion of the main frame 210 when the optical disc drive is positioned in the vertical direction.

The second stopper mechanism 240 may prevent the optical disc from dropping at the predetermined distance from the first stopper mechanism 230 to a left side or to a right side of the first stopper mechanism 230. As another example, the second stopper mechanism 240 may be disposed on each of the left side and the right side of the first stopper mechanism 230, such that the main frame 210 includes at least three stopper mechanisms. In addition to the first stopper mechanism 230, the second stopper mechanism 240 may be disposed on the floor plane of the main frame 210.

When the optical disc drive is disposed in the vertical direction, the optical disc may be held by the hook 250 of the disc tray 220, the first stopper mechanism 230, and the second stopper mechanism 240. According to various aspects, even though the optical disc drive is disposed in the vertical direction and performs the unloading operation of the optical disc in a state of being tilted at the predetermined angle toward a Z-axial direction, the optical disc drive may prevent a separation of the optical disc from the disc tray 220 using a double structure including the hook 250 of the main frame 210, the first stopper mechanism 230, and the second stopper mechanism 240. Accordingly, the optical disc drive may stably support the optical disc during the unloading operation of the optical disc through the use of the first stopper mechanism 230, and the second stopper mechanism 240 of the main frame 210.

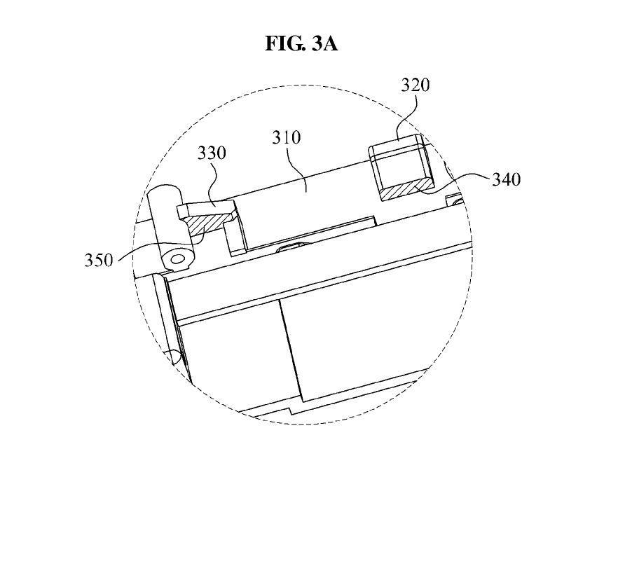

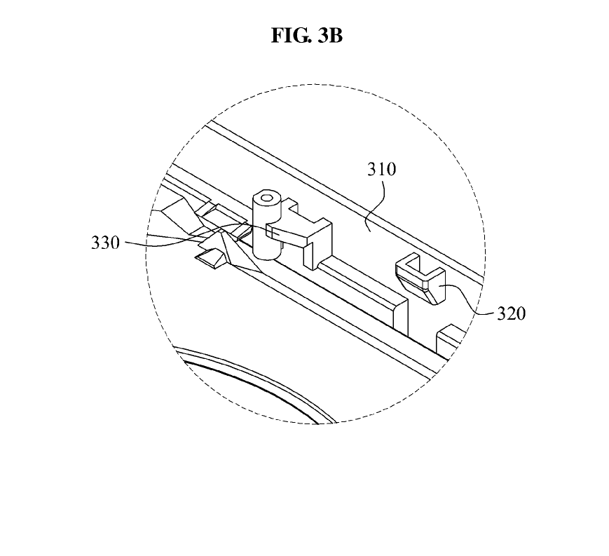

FIGS. 3A and 3B illustrate an example of a stopper mechanism.

FIG. 3A illustrates a first stopper mechanism 320 and a second stopper mechanism 330 of a main frame 310 viewed from the below. FIG. 3B illustrates the first stopper mechanism 320 and the second stopper mechanism 330 of the main frame 310 viewed from above. Referring to FIGS. 3A and 3B, the first stopper mechanism 320 has a center within a predetermined distance from a reference axis to which a center of the optical disc is connected, and the second stopper mechanism 330 holding an end portion of the optical disc is offset by a predetermined distance in a vertical direction relative to a plane of the optical disc.

A first hatched area 340 in the example of FIG. 3A indicates a side to which the optical disc is hooked by the first stopper mechanism 320, and a second hatched area 350 in FIG. 3A indicates a side to which the optical disc is hooked by the second stopper mechanism 330. In some examples, the first stopper mechanism 320 and the second stopper mechanism 330 may be provided in a shape of a rib to hold the optical disc.

When the optical disc drive is tilted at a predetermined angle while the optical disc drive is disposed in the vertical direction, the optical disc may be hooked to the first stopper mechanism 320 and the second stopper mechanism 330 by the first stopper mechanism 320 and the second stopper mechanism 330 provided in a shape of a rib during an unclamping operation of the optical disc drive. Accordingly, it is possible to prevent the optical disc from being separated from the disc tray during an unloading operation of the optical disc.

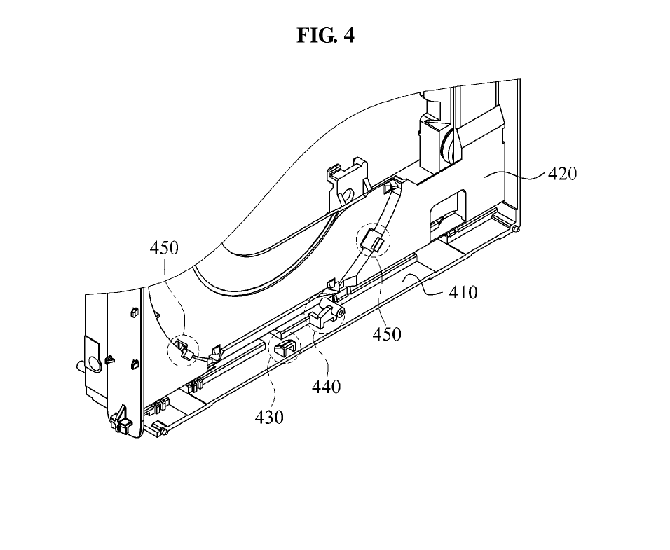

FIG. 4 illustrates an example of a stopper mechanism of an optical disc drive positioned in a vertical direction.

Referring to FIG. 4, the stopper mechanism is disposed in a main frame 410, in a state in which an optical disc drive is positioned in the vertical direction. A disc tray 420 may include a hook 450 to prevent separation of an optical disc. Here, the main frame 410 of the optical disc drive additionally includes a first stopper mechanism 430 and a second stopper mechanism 440 to prevent separation of the optical disc from the disc tray 420 when the optical disc drive is in a tilted state.

Although an unclamping operation is performed and the optical disc is externally ejected from the optical disc drive, the optical disc drive may stably hold the optical disc during the ejection using the first stopper mechanism 430, the second stopper mechanism 440, and the hook 450 of the disc tray 420. For example, the optical disc drive may stably perform an unloading operation by holding the optical disc in four locations. As an example, the four locations may include two points at which the respective hooks 450 of the disc tray 420 are disposed, and points at which the first stopper mechanism 430 and the second stopper mechanism 440 are disposed on a floor plane of the main frame 410, as described in FIG. 4. It should also be appreciated that more or less hooks 450 may be used, and the location of the hooks with respect to the first and second stopper mechanisms 430 and 440 may be arranged differently.

According to various aspects, an optical disc drive may be in a vertical direction in which the optical disc drive is parallel to ground. As a result, gravity may force an optical disc to become dislodged from a disc tray of the optical disc drive.

According to various aspects, an optical disc drive may stably operate by preventing separation of an optical disc from a disc tray by a force of gravity even though the optical disc drive is disposed to operate in a vertical direction. To support the optical disc, one or more stopper mechanisms may be included in the main frame of the optical disc drive. The stopper mechanisms may prevent the optical disc from becoming dislodged as a result of gravity and/or an external shock while the optical disc drive is disposed in the vertical direction.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An optical disc drive, comprising:
a disc tray configured to support an optical disc;
a main frame which supports the optical disc drive and the disc tray; and
a stopper mechanism disposed on the main frame and which is configured to prevent the optical disc from dropping while the optical disc is positioned in the disc tray.

2. The optical disc drive of claim 1, wherein the optical disc drive is a vertical optical disc drive, and the stopper mechanism holds the optical disc in order to prevent a free fall of the optical disc due to a force of gravity while an unclamping operation of the optical disc drive is performed.

3. The optical disc drive of claim 1, wherein the stopper mechanism comprises a shape of a rib to hold the optical disc toward a direction in which the optical disc drive is tilted.

4. The optical disc drive of claim 1, further comprising a hook disposed on the disc tray, wherein the stopper mechanism holds the optical disc in order to prevent separation of the optical disc from the hook of the disc tray.

5. The optical disc drive of claim 1, wherein the stopper mechanism prevents the drop of the optical disc from occurring when the optical disc drive is tilted at a predetermined angle while the optical disc drive is disposed in a vertical direction.

6. The optical disc drive of claim 1, wherein the stopper mechanism comprises a center that is within a predetermined distance from a reference axis to which a center of the optical disc is connected, and holds an end portion of the optical disc in a vertical direction relative to a plane of the optical disc.

7. The optical disc drive of claim 1, wherein the stopper mechanism holds the end portion of the optical disc, which is offset by a predetermined distance, in a vertical direction relative to a plane of the optical disc.

8. The optical disc drive of claim 1, wherein the stopper mechanism comprises:
a first stopper mechanism comprising a center that is within a predetermined distance from a reference axis to which a center of the optical disc is connected, and which holds an end portion of the optical disc in a vertical direction relative to a plane of the optical disc; and
a second stopper mechanism that holds the end portion of the optical disc, and which is offset by a predetermined distance, in the vertical direction relative to the plane of the optical disc.

9. The optical disc drive of claim 1, wherein the disc tray comprises at least one hook that is configured to hold the optical disc in a vertical direction relative to a plane of the optical disc.

10. The optical disc drive of claim 9, wherein the optical disc is held by the at least one hook while the optical disc drive is disposed in the vertical direction, and held by the stopper mechanism when the optical disc drive is tilted at a predetermined angle while the optical disc drive is disposed in the vertical direction.

11. A main frame of an optical disc drive, the main frame comprising:
a stopper mechanism configured to prevent an optical disc disposed on a disc tray from dropping,
wherein the stopper mechanism is configured to prevent dropping of the optical disc when the optical disc drive is tilted at a predetermined angle while the optical disc drive is disposed in a vertical direction.

12. The main frame of claim 11, wherein, during an unclamping operation of the optical disc drive, the stopper mechanism holds the optical disc to prevent a free fall of the optical disc due to a force of gravity.

13. The main frame of claim 11, wherein the stopper mechanism comprises a shape of a rib to hold the optical disc toward a direction in which the optical disc drive is tilted.

14. The main frame of claim 11, wherein the stopper mechanism holds the optical disc in order to prevent separation of the optical disc from a hook disposed on the disc tray.

15. The main frame of claim 11, wherein the stopper mechanism comprises:
a first stopper mechanism that has a center within a predetermined distance from a reference axis to which a center of the optical disc is connected and which holds an end portion of the optical disc in a vertical direction relative to a plane of the optical disc; and
a second stopper mechanism configured to hold the end portion of the optical disc and which is offset by a predetermined distance in the vertical direction relative to the plane of the optical disc.

16. An optical disc drive, comprising:
a disc tray comprising a hook that is configured to hold an optical disc while the optical disc drive is disposed in a vertical direction; and
a main frame comprising a stopper mechanism configured to hold the optical disc when the optical disc drive is tilted at a predetermined angle while the optical disc drive is disposed in the vertical direction.

17. The optical disc drive of claim 16, wherein the stopper mechanism prevents the optical disc from a free fall by a force of gravity while an unclamping operation of the optical disc drive is performed.

18. The optical disc drive of claim 16, wherein the stopper mechanism is configured to hold the optical disc in order to prevent separation of the optical disc from the hook of the disc tray.

19. The optical disc drive of claim 16, wherein the stopper mechanism comprises:
a first stopper mechanism that has a center within a predetermined distance from a reference axis to which a center of the optical disc is connected and which holds an end portion of the optical disc in a vertical direction relative to a plane of the optical disc; and
a second stopper mechanism that holds the end portion of the optical disc and which is offset by a predetermined distance, in the vertical direction relative to the plane of the optical disc.
